(19) United States
(12) Patent Application Publication
(10) Pub. No.: US 2013/0130716 A1
(43) Pub. Date: May 23, 2013

(54) METHOD FOR OBTAINING REPORT INFORMATION IN SHORT MESSAGE SERVICE

(71) Applicant: Kuo-Hao Hung, New Taipei City (TW)

(72) Inventor: Kuo-Hao Hung, New Taipei City (TW)

(21) Appl. No.: 13/403,951

(22) Filed: Feb. 23, 2012

(30) Foreign Application Priority Data
Nov. 22, 2011 (TW) 100142693

(51) Int. Cl. H04W 4/14; H04W 4/02

(52) U.S. Cl. 455/456.2; 455/466

(57) ABSTRACT

A method for obtaining report information in short message service includes defining a first information element identifier (IEI) as a report request and defining a second IEI as a report response in transfer protocol user data (TPUD); operating a first electronic device to generate a first short message; the first electronic device setting the first IEI and a first information element data (IED) in the first short message; operating the first electronic device to transmit the first short message to a second electronic device; operating the second electronic device to read the first short message; the second electronic device generating a second short message according to the first short message, setting the second IEI and a second IED in the second short message, and transmitting the second short message to the first electronic device; and the first electronic device displaying a report information according to the second short message.

### BACKGROUND OF THE INVENTION

1. Field of the Invention

The invention relates to a method for obtaining report information in short message service and, more particularly, to a method enabling an electronic device to report specific information while transmitting and receiving short message.

2. Description of the Prior Art

So far short message service (SMS) is the most popular mobile communication service. SMS is introduced into mobile phone with Global System for Mobile Communications (GSM) in the beginning but can be used on most mobile phones nowadays, such as 3G phone and so on. When a user cannot talk to somebody through a mobile phone under some situations or due to some reasons or uses a tablet computer, which only provides data service with packet switch, the user may exchange information with somebody through SMS. However, in the present SMS, the user cannot know whether the other side has received and read short message after transmitting the short message. It is very inconvenient for the user. Furthermore, in the present SMS, the user also cannot use short message to request a mobile phone of the other side to report specific information such that the application of SMS is limited.

### SUMMARY OF THE INVENTION

Therefore, an objective of the invention is to provide a method for obtaining report information in short message service. The method enables an electronic device to report specific information while transmitting and receiving short message so as to solve the aforesaid problems.

According to an embodiment of the invention, a method for obtaining report information in short message service comprises steps of: defining a first information element identifier (IEI) as a report request and defining a second IEI as a report response in transfer protocol user data (TPUD) ; operating a first electronic device to generate a first short message; the first electronic device setting the first IEI and a first information element data (IED) in the first short message; operating the first electronic device to transmit the first short message to a second electronic device; operating the second electronic device to read the first short message; the second electronic device generating a second short message according to the first IEI and the first IED of the first short message, setting the second IEI and a second IED in the second short message, and transmitting the second short message to the first electronic device; and the first electronic device displaying a report information according to the second IEI and the second IED of the second short message.

In this embodiment, the report request may be a read report request, the report response may be a read report response, and a content of the report information may be that the first short message has been read. At this time, each of the first IED and the second IED comprises a serial number corresponding to the first short message.

In another embodiment, the report request may be a location report request, the report response may be a location report response, and a content of the report information may be a location information of the second electronic device. At this time, the first IED comprises a serial number corresponding to the first short message and the second IED comprises the serial number corresponding to the first short message and the location information of the second electronic device.

As mentioned in the above, the invention utilizes IEI to define “report request” and “report response” in TPUD. When a user operates the first electronic device to transmit the first short message to the second electronic device and requests the second electronic device to report specific information (e.g. read report, location report or other information reports), the first electronic device will set one IEI of TPUD in the first short message as “report request” and set an IED (e.g. a serial number corresponding to the first short message) correspondingly. When another user reads the first short message on the second electronic device, the second electronic device will compare whether the IEI of TPUD is defined as “report request”. If the IEI of TPUD is defined as “report request”, the second electronic device will transmit a second short message back to the first electronic device, wherein the second electronic device will set one IEI of TPUD in the second short message as “report response” and set an IED (e.g. a serial number corresponding to the first short message and/or other report information) correspondingly. After receiving the second short message from the second electronic device, the first electronic device will display a report information on a display device, such as “the first short message has been read”, “location information of the second electronic device” or other specific information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1A and 1B are flowcharts illustrating a method for obtaining report information in short message service according to an embodiment of the invention.

FIG. 2 is a schematic diagram illustrating a first electronic device, a short message service center and a second electronic device used for implementing the method shown in FIGS. 1A and 1B.

### DETAILED DESCRIPTION

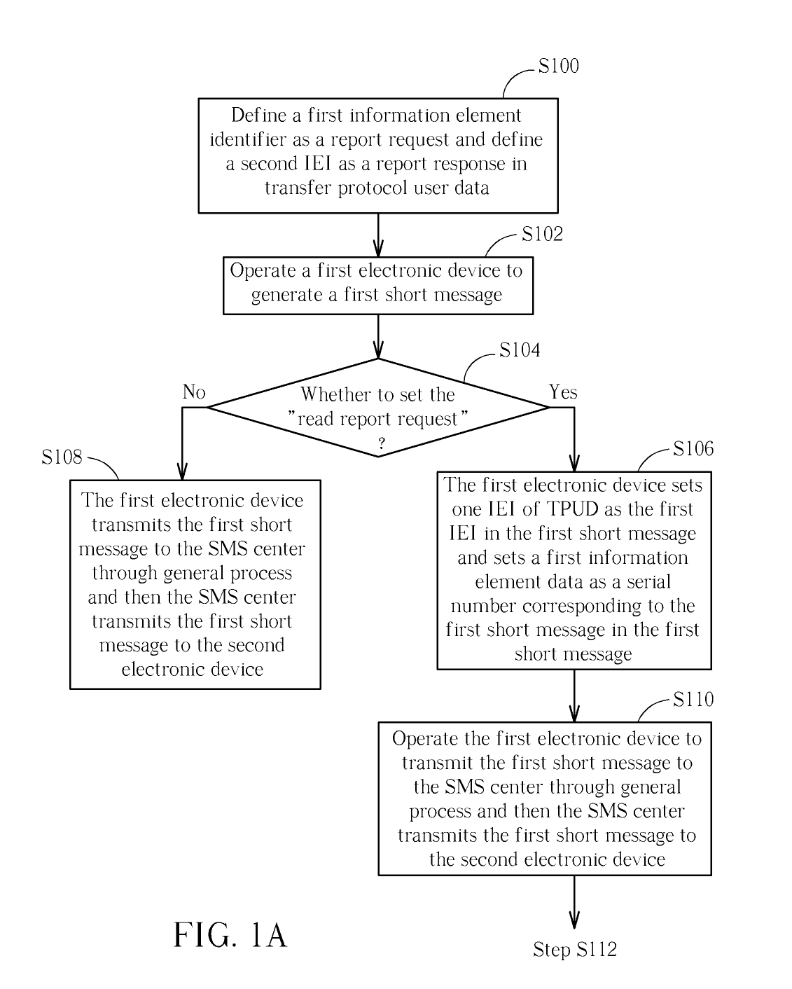

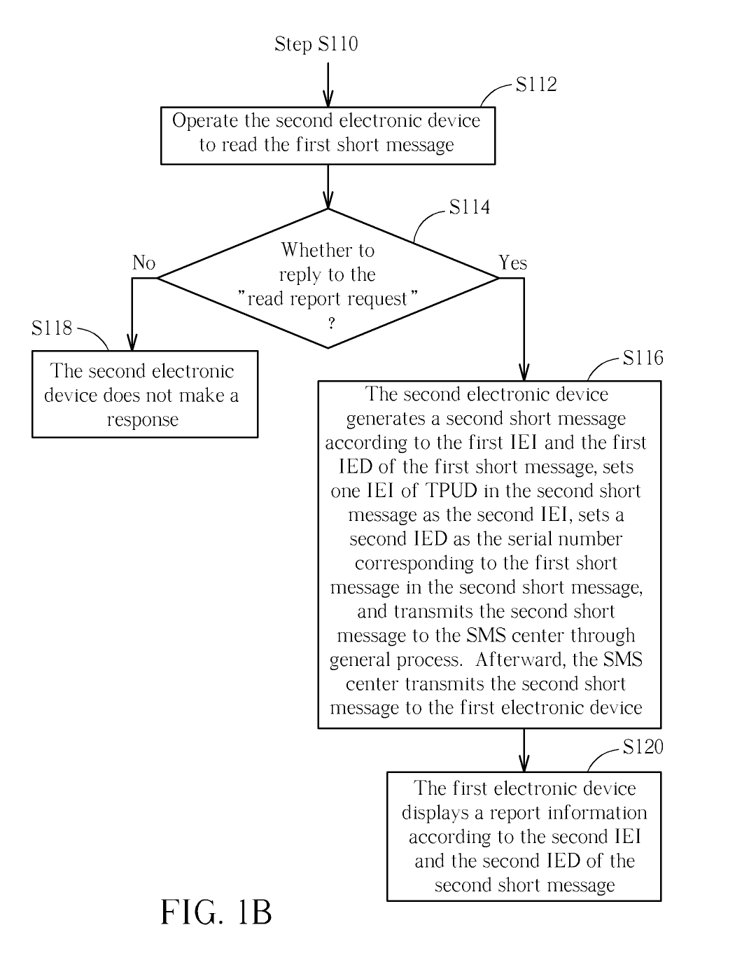

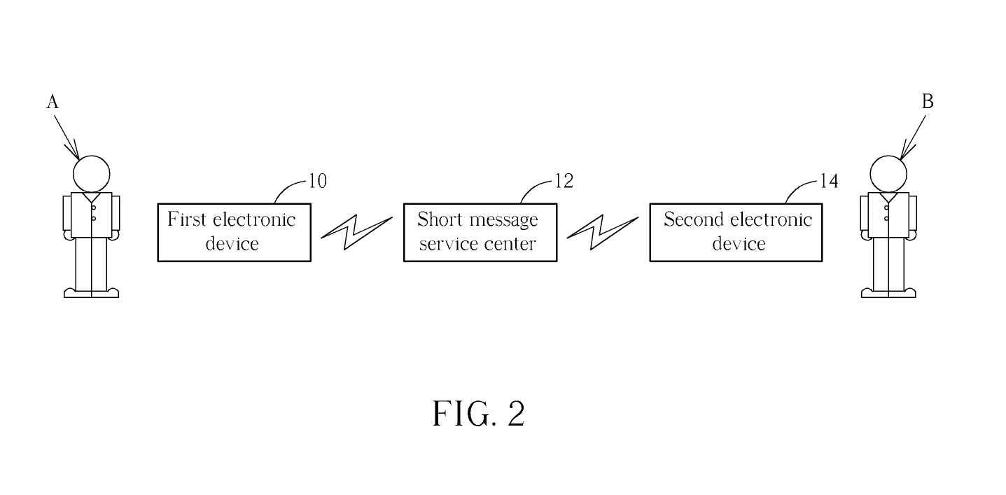

Referring to FIGS. 1A, 1B and 2, FIGS. 1A and 1B are flowcharts illustrating a method for obtaining report information in short message service according to an embodiment of the invention, and FIG. 2 is a schematic diagram illustrating a first electronic device 10, a short message service center 12 and a second electronic device 14 used for implementing the method shown in FIGS. 1A and 1B. The first electronic device 10 and the second electronic device 14 may be any electronic devices capable of transmitting and receiving short message in short message service (SMS), such as mobile phone, flat computer, personal digital assistant (PDA) and so on.

First of all, step 5100 is performed to define a first information element identifier (IEI) as a report request and define a second IEI as a report response in transfer protocol user data (TPUD). In other words, the invention utilizes TPUD of SMS to report a little amount of data without changing SMS protocol in mobile communication network. The following takes the “report request” and the “report response” to be “read report request” and “read report response” for depicting the features of the invention. In IEI's definition of TPUD, 0A-6F, A0-BF and E0-FF are reserved for future applications. Therefore, for example, the invention may set the first IEI of TPUD as “0A” for the definition of “read report request” and set the second IEI of TPUD as “A0” for the definition of “read report response”.

In step 5102, a user A can operate a first electronic device 10 to generate a first short message. At this time, the first electronic device 10 may provide a user interface for the user A to select whether to set the “read report request” (step S104). If the user A selects to set the “read report request”, the first electronic device 10 sets one IEI of TPUD as the first IEI “0A” in the first short message and sets a first information element data (IED) as a serial number corresponding to the first short message in the first short message (step S106). On the other hand, if the user A selects not to set the “read report request”, the first electronic device 10 transmits the first short message to the SMS center 12 through general process and then the SMS center 12 transmits the first short message to the second electronic device 14 (step S108).

It should be noted that the invention may also set the “read report request” automatically while the user A operates the first electronic device 10 to generate the first short message instead of manual setting.

After step 5106, the user A can operate the first electronic device 10 to transmit the first short message to the SMS center 12 through general process and then the SMS center 12 transmits the first short message to the second electronic device 14 (step S110). After the second electronic device 14 receives the first short message, a user B can operate the second electronic device 14 to read the first short message (step S112). If the second electronic device 14 determines that one IEI of TPUD in the first short message is defined as the first IEI “0A” while reading the first short message, the second electronic device 14 may provide a user interface for the user B to select whether to reply to the “read report request” set by the user A (step S114). If the user B selects to reply to the “read report request”, the second electronic device 14 will generate a second short message according to the first IEI “0A” and the first IED of the first short message, set one IEI of TPUD in the second short message as the second IEI “A0”, set a second IED as the serial number corresponding to the first short message in the second short message, and transmit the second short message to the SMS center 12 through general process. Afterward, the SMS center 12 transmits the second short message to the first electronic device 10 (step S116). On the other hand, if the user B selects not to reply to the “read report request”, the second electronic device 14 does not make a response accordingly (step S118).

It should be noted that the invention may also reply to the “read report request” automatically while the user B operates the second electronic device 14 to read the first short message instead of manual operation.

After receiving the second short message, the first electronic device 10 will display a report information for the user A according to the second IEI “A0” and the second IED of the second short message (step S120). In this embodiment, a content of the report information is that the first short message has been read. Accordingly, the user can know whether the other side has received and read short message after transmitting the short message. It is very convenient for the user who transmitting the short message.

Similarly, in another embodiment, the aforesaid report request may be a location report request, the aforesaid report response may be a location report response, and a content of the aforesaid report information may be a location information of the second electronic device 14 correspondingly. For example, if the second electronic device 14 has Global Positioning System (GPS) or other positioning technology, the invention may set the first IEI of TPUD as “6F” for the definition of “location report request” and set the second IEI of TPUD as “BF” for the definition of “location report response”. At this time, the aforesaid second IED of the second short message may further comprise a location information of the second electronic device 14 (e.g. coordinate, longitude, latitude and so on) except the serial number corresponding to the first short message. Furthermore, all of the aforesaid steps can be applied to this embodiment and will not be depicted herein again. Accordingly, the user can use short message to request an electronic device of the other side to report location information and even other specific information so as to expand the application of SMS.

Compared with the prior art, the invention utilizes IEI to define “report request” and “report response” in TPUD. When a user operates the first electronic device to transmit the first short message to the second electronic device and requests the second electronic device to report specific information (e.g. read report, location report or other information reports), the first electronic device will set one IEI of TPUD in the first short message as “report request” and set an IED (e.g. a serial number corresponding to the first short message) correspondingly. When another user reads the first short message on the second electronic device, the second electronic device will compare whether the IEI of TPUD is defined as “report request”. If the IEI of TPUD is defined as “report request”, the second electronic device will transmit a second short message back to the first electronic device, wherein the second electronic device will set one IEI of TPUD in the second short message as “report response” and set an IED (e.g. a serial number corresponding to the first short message and/or other report information) correspondingly. After receiving the second short message from the second electronic device, the first electronic device will display a report information on a display device, such as “the first short message has been read”, “location information of the second electronic device” or other specific information.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for obtaining report information in short message service comprising:
defining a first information element identifier (IEI) as a report request and defining a second IEI as a report response in transfer protocol user data (TPUD);
operating a first electronic device to generate a first short message;
the first electronic device setting the first IEI and a first information element data (IED) in the first short message;
operating the first electronic device to transmit the first short message to a second electronic device;
operating the second electronic device to read the first short message;
the second electronic device generating a second short message according to the first IEI and the first IED of the first short message, setting the second IEI and a second IED in the second short message, and transmitting the second short message to the first electronic device; and
the first electronic device displaying a report information according to the second IEI and the second IED of the second short message.

2. The method of claim 1, wherein operating a first electronic device to generate a first short message comprises:
the first electronic device providing a user interface for a user to select whether to set the report request; and
if the user selects to set the report request, the first electronic device setting the first IEI in the first short message.

3. The method of claim 1, wherein operating the second electronic device to read the first short message comprises:
the second electronic device providing a user interface for a user to select whether to reply to the report request; and
if the user selects to reply to the report request, the second electronic device generating the second short message.

4. The method of claim 1, wherein the report request is a read report request, the report response is a read report response, and a content of the report information is that the first short message has been read.

5. The method of claim 4, wherein each of the first IED and the second IED comprises a serial number corresponding to the first short message.

6. The method of claim 1, wherein the report request is a location report request, the report response is a location report response, and a content of the report information is a location information of the second electronic device.

7. The method of claim 6, wherein the first IED comprises a serial number corresponding to the first short message and the second IED comprises the serial number corresponding to the first short message and the location information of the second electronic device.
